(19) United States
(12) Patent Application Publication
(10) Pub. No.: US 2026/0104617 A1
(43) Pub. Date: Apr. 16, 2026

(54) ELECTROPHORESIS DISPLAY WITH SUPPORT STRUCTURE

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW); Chia-Cheng LEI, New Taipei City (TW); Kun-Yu CHEN, New Taipei City (TW)

(73) Assignee: SUPERC-TOUCH CORPORATION, New Taipei City (TW)

(21) Appl. No.: 19/350,729

(22) Filed: Oct. 6, 2025

(30) Foreign Application Priority Data
Oct. 15, 2024 (TW) 113139193

(51) Int. Cl. G02F 1/1685; G02F 1/1362; G02F 1/1368; G02F 1/167

(52) U.S. Cl. CPC G02F 1/1685; G02F 1/136286; G02F 1/1368; G02F 1/167

(57) ABSTRACT

An electrophoresis display with support structure includes a control substrate, an opposite substrate, an electrophoresis material layer arranged between the two substrates, a pixel electrode layer including a plurality of pixel electrodes and a pixel gap defined between two adjacent pixel electrodes, a plurality supporting structures with supporting structure gap therebetween and the supporting structure gap having at least one size. A colloidal solution is at least filled between the supporting structures.

### CROSS-REFERENCE TO RELATED APPLICATION

This application claims benefit of priority to Taiwanese Patent Application No. 113139193 filed Oct. 15, 2024, the entire contents of which are incorporated herein by reference.

### BACKGROUND OF THE INVENTION

### Technical Field

The present invention relates to an electrophoresis display, and more particularly to an electrophoresis display with support structure.

### Description of Related Art

The ideal electronic paper needs to have advantages of lightweight, low energy consumption, and flexibility. In addition, electronic paper can retain images even after power off. Therefore, electronic paper has been widely used in applications such as books, labels, posters, bulletin boards, etc. In the past, various electronic paper technologies have been proposed, such as electronic powder fluid (quick response liquid powder display), cholesteric liquid crystal display and other displays. However, electrophoresis displays (EPDs) are still the mainstream in view of practical considerations such as image display quality, electronic drive system design complexity and mass production stability. In addition, with more desirable application, color electronic paper has gradually become a development focus.

The colloidal solution containing charged color particles in current electrophoresis displays is mainly filled in the schemes of micro-cups or micro-partition. The micro-partition scheme provides precise positioning in non-display area of the display area (such as between pixels) to prevent from degrading display quality. The high precision results provided by the micro-partition scheme have excellent yields and reduced production costs. Besides, the micro-partition scheme eliminates the expense and cost of conventional micro-cup e-paper production. The skip of substrate lamination saves the expense of optical adhesive and prevents from the resulting yield loss, thus enabling the production of thinner electrophoresis displays. However, the current method of injecting the colloidal solution into the micro-partition structure uses a dispensing method. There will be uneven filling problem if traditional panel makers' ODM (one-drop) systems are employed.

### SUMMARY OF THE INVENTION

The object of the present invention is to solve the problem of uneven ink filling in micro partition structure.

Accordingly, the present invention provides an electrophoresis display having support structure, the electrophoresis display comprising:
a control substrate having a first face and a second face;
an opposite substrate having a third face and a fourth face;
an electrophoresis display material layer filled with a colloidal solution containing at least one type of charged color particles, the electrophoresis display material layer being arranged between the control substrate and the opposite substrate;
the electrophoresis display further comprising, on the second face of the control substrate, a thin-film transistor circuit layer comprising a plurality of thin-film transistors, a plurality of gate lines, and a plurality of data lines, at least one of the gate lines being electrically connected to gates of the plurality of thin-film transistors, and at least one of the data lines being electrically connected to drains or sources of the plurality of thin-film transistors;
a pixel electrode layer comprising a plurality of pixel electrodes;
a plurality of support structures, the support structures having a support structure gap between two adjacent support structures;
wherein the support structure gaps have at least one size, and the colloidal solution is filled between the support structures; when the colloidal solution is filled, the colloidal solution flows within the support structure gaps;
wherein at least one of the support structures encloses a chamber capable of being filled with the colloidal solution containing the charged color particles, the ratio of a total width of the support structure gaps corresponding to the chamber to the total perimeter of the chamber is greater than 5%.

### BRIEF DESCRIPTION OF THE DRAWINGS

FIG. 1A is a cross-sectional view of an electrophoresis display.

FIG. 1B shows an equivalent circuit diagram of partial components in the pixel electrode layer and the driving circuit layer.

FIG. 2 shows the top view of the micro-cup compartments in the prior art electrophoresis display and the relevant color filter layers.

FIG. 3 is a top view of the micro-partitions structure according to the present invention.

FIG. 4A shows the structure of an electrophoresis display, the micro-partition structure of the present invention is applicable to the electrophoresis display.

FIG. 4B shows the structure of another electrophoresis display, the micro-partition structure of the present invention is applicable to the electrophoresis display.

FIG. 4C shows the structure of still another electrophoresis display, the micro-partition structure of the present invention is applicable to the electrophoresis display.

FIGS. 5A to 5I are top views showing support structures according to different embodiments of the present invention.

FIGS. 6A to 6D are top views showing support structures according to different embodiments of the present invention.

FIG. 7A is top view showing the distribution of multiple support structures on the surface of the electrophoresis display according to one embodiment of the present invention.

FIG. 7B is top view showing the distribution of multiple support structures on the surface of the electrophoresis display according to another embodiment of the present invention.

FIGS. 8A and 8B respectively show cross-sectional views along lines a-a′ and b-b′ in FIG. 7A.

FIG. 9 is top view showing the distribution of multiple support structures on the surface of the electrophoresis display according to still another embodiment of the present invention.

FIGS. 10A and 10B respectively show cross-sectional views along lines a-a′ and b-b′ in FIG. 9.

FIGS. 11A and 11B respectively show cross-sectional views along lines a-a′ and b-b′ in FIG. 7B.

### DETAILED DESCRIPTION

The technical contents of this invention will become apparent with the detailed description of embodiments accompanied with the illustration of related drawings as follows. It is intended that the embodiments and drawings disclosed herein are to be considered illustrative rather than restrictive.

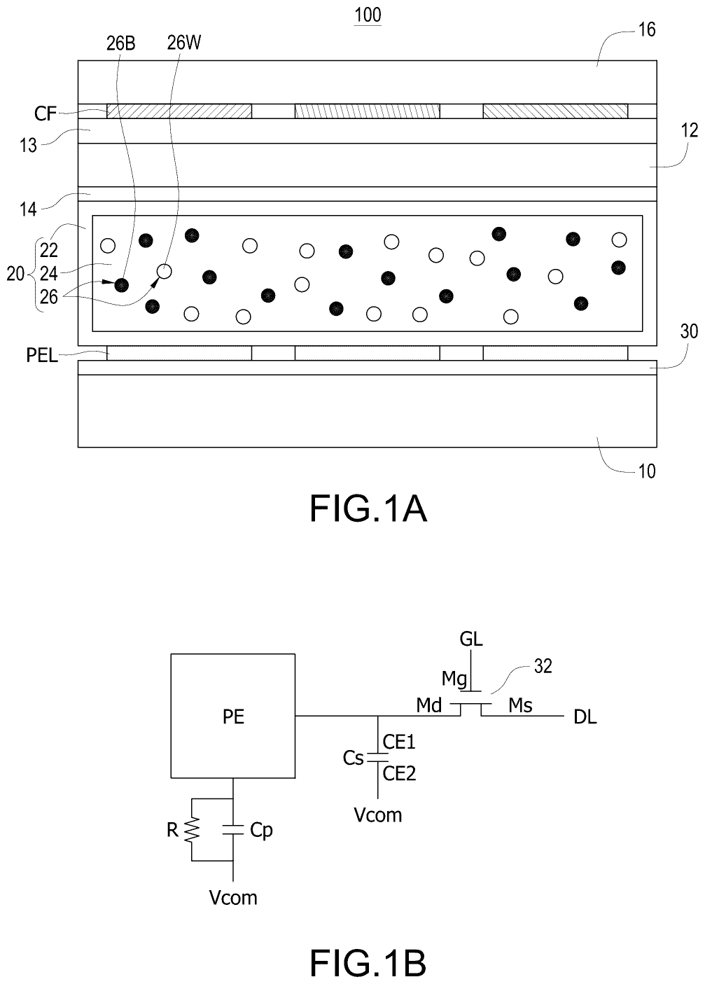

FIG. 1A is a cross-sectional view of an electrophoresis display 100. The electrophoresis display 100 is, for example, a color electrophoresis display 100. The electrophoresis display 100 includes, from top to bottom, an upper glass substrate 16, a color filter layer CF, an optical adhesive 13, an opposite substrate 12 (such as a transparent plastic substrate), a common electrode layer 14 (such as a transparent conductive electrode layer), an electrophoresis layer 20, a pixel electrode layer PEL, a driving circuit layer 30, and a control substrate 10 (such as a glass substrate).

The electrophoresis layer 20 comprises a plurality of hollow cavities 22 (only one hollow cavity 22 is shown in FIG. 1). Each cavity 22 is filled with a colloidal solution 24 containing a plurality of suspended charged color particles 26 (for example, charged black particles 26B and charged white particles 26W). The hollow cavities 22 are used as containers for the electronic ink (or electrophoresis material). The hollow cavities 22 are made of, for example, an organic polymer material and are used to contain the charged color particles 26.

FIG. 1B shows an equivalent circuit diagram of partial components in the pixel electrode layer PEL/driving circuit layer 30. As shown in FIG. 1B and with reference also to FIG. 1A, the common electrode layer 14 is generally electrically connected to ground potential (0V, namely the Vcom level) and the electrophoresis layer 20 is sandwiched between the common electrode layer 14 and the pixel electrode layer PEL. The pixel electrode PE of the pixel electrode layer PEL forms a capacitor (electrophoresis capacitor Cp) with the Vcom level. A storage capacitor Cs has one end (namely, the capacitor electrode CE1) connected to the pixel electrode PE, and the other end (namely, the capacitor electrode CE2) forms a parallel-plane capacitor on the conductor on the other side of the pixel electrode PE facing the electrophoresis layer. FIG. 1B shows the equivalent circuit of the electrophoresis layer 20 as an electrophoresis capacitor Cp in parallel with a resistor R (equivalent to the energy consumed by the movement of the charged color particles). Besides, the equivalent circuit of the electrophoresis layer 20 further includes the aforementioned storage capacitor Cs. With reference also to FIG. 1A, the driving circuit layer 30 includes a plurality of thin film transistors (not shown); and with reference again to FIG. 1B, the gate metal Mg of each thin film transistor 32 is electrically connected to the gate line GL, the source metal Ms is electrically connected to the data line DL, and the drain metal Md is electrically connected to the corresponding pixel electrode PE. The electric potential applied to the gate metal Mg by the gate line GL determines whether the thin film transistor 32 is turned on or off. In this way, it determines whether the source metal Ms transmits the voltage from the data line DL to the drain metal Md, and further transmits the voltage to the corresponding pixel electrode PE. The voltage will charge the storage capacitor Cs to have the same voltage as that in the data line DL. The pixel electrode PE also applies the voltage on the corresponding data line to the electrophoresis layer 20. In principle, the driving circuit layer 30 includes multiple thin-film transistors, multiple gate lines, and multiple data lines. Each gate line is electrically connected to the gates of the multiple thin-film transistors, and each data line is electrically connected to the drains or sources of the multiple thin-film transistors.

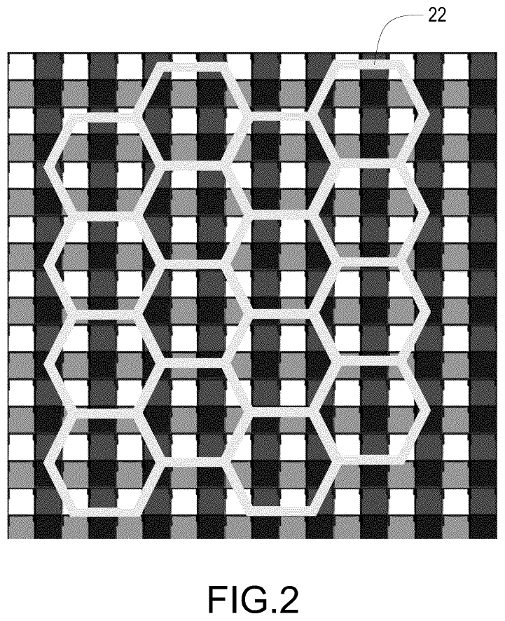

FIG. 2 shows the top view of the micro-cup compartments in the prior art electrophoresis display and the relevant color filter layers. The compartment walls of the micro-cups 22 need to be thicker than 10 micrometers (um) to provide sufficient support. Besides, along a projection direction atop the micro-cup compartments in the prior art electrophoresis display, the micro-cup compartments need to have a hexagonal compartment structure to enhance structural strength. The regions on the cross-section of the micro-cup compartments are not reachable by the charged color particles such that the regions on the cross-section of the micro-cup compartments are key factors for affecting the display aperture ratio. The prior art electrophoresis display does not have charged color particles at such regions. When the micro-cup compartments shown in FIG. 2 are attached to a control substrate (such as the control substrate 10 shown in FIG. 1A), they block the electrodes on the control substrate. As a result, part of the displayed color is blocked and background textures are produced to affect the image quality. Besides, the non-uniformity caused by the blocking positions of the micro-cup compartments on the color filter layer results in color distortion.

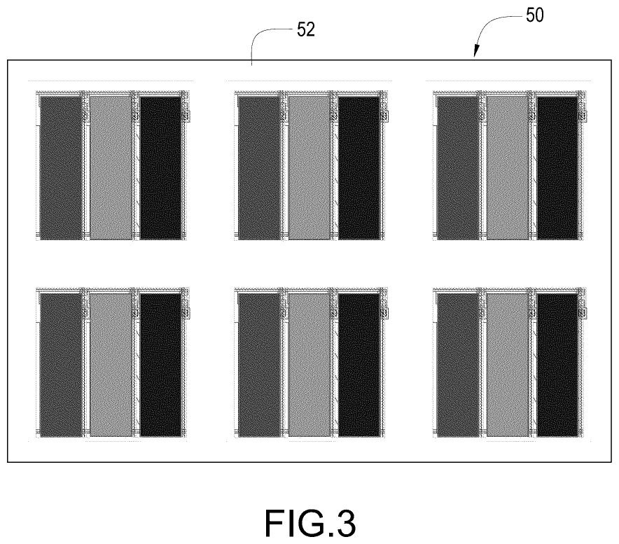

With reference to FIG. 3, according to one embodiment of the present invention, the micro-partitions are fabricated on a substrate such that the pixel electrodes PE are precisely aligned. For example, the support structures 52 of the micro-partition structure 50 are fabricated on the non-display area between pixels. According to the design of the present invention, the support structure 52 of the micro-partition structure 50, after the combination thereof, can form a rectangular structure with shape close to the shape of the pixel. The rectangular structure can also be fitted to the border of the pixel to prevent from affecting display quality. According to the present invention, for example, a photo mask can be used to develop a pattern of a photoresist film to fabricate the support structure 52, wherein the photoresist film can be made of a material with a relatively high hardness. For example, the photoresist film can be a transparent photoresist made of acrylic. Besides, according to other embodiments of the present invention, the support structures 52 of the micro-partition structure 50 may also be made of a polymer material (such as a planarization layer material, resin, or acrylic material). In addition, the support structures 52 of the micro-partition structure 50 may be partially aligned with the gate lines GL or the data lines DL. More specifically, the multiple support structures 52 may be overlapped with portions of the data lines DL and/or the gate lines GL along a vertical projection direction (namely, along the direction perpendicular to the viewing surface).

The present invention employs a hard polymer material (such as a transparent photoresist) as the support structure 52 of the micro-partition structure 50. For example, the hardness of the hard polymer material can be larger than 3H pencil hardness, this hardness is far beyond the hardness of the resin material used in prior micro-cup containers (the hardness thereof is less than 1H). Therefore, the support structure 52 according to the present invention can support the weight and pressure of the upper and lower substrates with thinner walls. The thickness of the support structure 52 can be less than 10 micrometers (um). The support structure 52 of the micro-partition structure 50 of the present invention can be precisely positioned on the non-display area (the area between pixels) of the electrophoresis display. Therefore, the micro-partition structure 50 of the present invention does not affect the display quality. The high precision provided by the micro-partition structure 50 of the present invention can enhance yields and reduce production costs. The support structure 52 of the present invention can even achieve more important advantage in that the cost for fabricating the prior art micro-cup in e-paper production can be eliminated. Besides, the support structure 52 of the present invention does not need the substrate lamination process to save the cost for optical adhesive and prevent the yield reduction caused by the substrate lamination process. The electrophoresis display can be made thinner. Besides, the micro-partition structure 50 can be fabricated by etching planarization layer (PLN) material to peel off the region not belonging to the wall to finish the micro-partition structure. Therefore, the micro-partition structure 50 of the present invention can be used to produce thinner electrophoresis display, for example, electrophoresis display with electrophoresis layer having thickness smaller than 25 micrometers (um), the height of the wall of the micro-partition structure 50 is smaller than 25 micrometers (um). As the electrophoresis layer of an electrophoresis display using the micro-partition structure 50 of the present invention become thinner, the distance between the pixel electrode and the common electrode is closer and the electric field strength is stronger to lower the driving voltage, speed up the movement of charged color particles and reduce the moving distance of the charged color particles. Therefore, the refreshing rate of the displayed screen is increased to solve the image refresh issue annoying the electrophoresis displays. This issue is particularly important in color electrophoresis displays.

For the micro-cup structure shown in FIG. 2, the prior art uses a printing method to fill the compartments defined by the micro-cup structure with a colloidal solution containing suspended charged color particles. For the micro-partition structure 50 shown in FIG. 3, even a dispenser can be used to fill the colloidal solution containing suspended charged color particles into compartment defined by the micro-partition structure 50; however, the one drop system used in the conventional panel manufacturer causes uneven ink filling. Therefore, the micro-partition structure 50 shown in FIG. 3 needs further improvements.

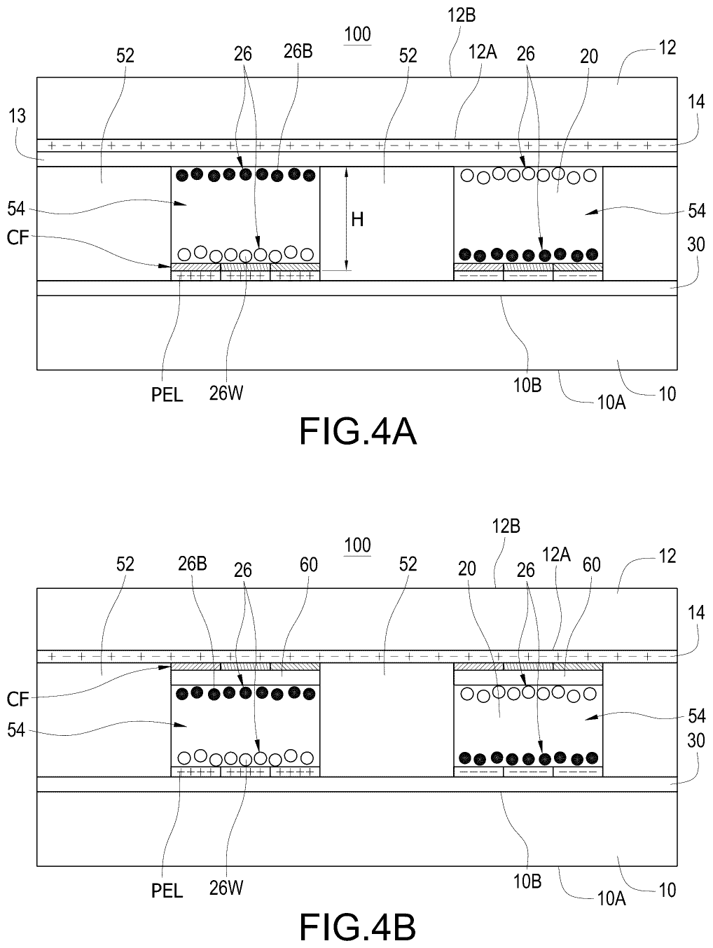

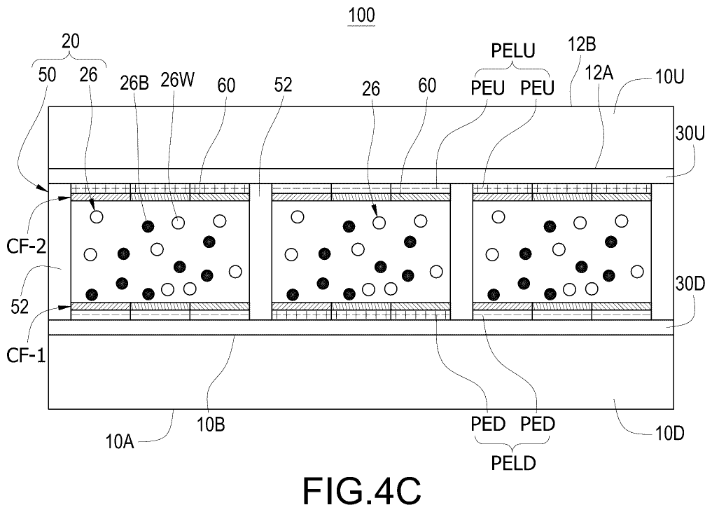

FIG. 4A shows the structure of an electrophoresis display 100, the micro-partition structure 50 of the present invention is applicable to the electrophoresis display 100. The electrophoresis display 100 includes, from top to bottom, an opposite substrate 12 (for example, a transparent plastic substrate or a glass substrate) having a third face 12A and a fourth face 12B, a common electrode layer 14 (for example, a transparent conductive electrode layer), an optical adhesive 13, an electrophoresis layer 20, a color filter layer CF, a pixel electrode layer PEL, a high aperture ratio driving circuit layer 30 (hereinafter referred to as the driving circuit layer 30), and a transparent control substrate 10 (for example, a glass substrate) having a first face 10A and a second face 10B. In addition, as shown in this figure, the electrophoresis layer 20 includes a micro-partition structure 50 composed of a plurality of support structures 52, and these support structures 52 define a plurality of chambers 54 (two chambers 54 are shown in the figure), and a colloidal solution 24 containing a plurality of charged color particles 26 (for example, charged black particles and charged white particles) filled in each of the chambers 54.

The details on above-mentioned high aperture ratio driving circuit layer 30 can be referred to Taiwan invention patent publication TW202403420 also filed by the same applicant's, which is incorporated here for reference. For one feasible implementation of the high aperture ratio driving circuit layer 30, for example, at least part or all of the gate lines originally made of the first metal layer are replaced with a first transparent conductive layer to form transparent conductive gate lines; alternatively, at least part or all of the data lines of the second metal layer are replaced with a second transparent conductive layer to form transparent conductive data lines, thereby increasing the aperture ratio when the electrophoresis display is viewed from the control substrate 10 side. Furthermore, according to one embodiment of the present invention, the ratio between the gate channel width W of the thin-film transistor and the gate channel length L of the thin-film transistor is 1:1. Namely, the gate channel length L is equal to the gate channel width W. This increases the aperture ratio of the electrophoresis display 100. For achieving a high aperture ratio driving circuit layer 30, more details can be found in Taiwan Invention Patent Publication TW202403420. In the electrophoresis display 100 shown in FIG. 4A, the viewing direction can be viewed from the control substrate 10 side, which is closer to the high aperture ratio driving circuit layer 30. This improves the response speed of the electrophoresis display 100.

FIG. 4B shows the structure of another electrophoresis display 100, the micro-partition structure 50 of the present invention is applicable to the shown electrophoresis display 100. The electrophoresis display 100 includes, from top to bottom, an opposite substrate 12 (for example, a transparent plastic substrate or a glass substrate) having a third face 12A and a fourth face 12B, a common electrode layer 14 (for example, a transparent conductive electrode layer), an electrophoresis layer 20, a pixel electrode layer PEL, a high aperture ratio driving circuit layer 30 (hereinafter referred to as the driving circuit layer 30), and a transparent control substrate 10 (for example, a glass substrate) having a first face 10A and a second face 10B. As shown in this figure, the electrophoresis layer 20 includes a micro-partition structure 50 formed by a plurality of support structures 52. These support structures 52 define a plurality of chambers 54 (two chambers 54 are shown in this figure), and a colloidal solution 24 containing a plurality of charged color particles (for example, charged black particles and charged white particles) is filled in each of the chambers 54. Furthermore, the opposite substrate 12 further includes a color filter layer CF located on the common electrode layer 14 and extending toward the electrophoresis layer 20, and micro tenons 60. The micro tenons 60 are configure to be inserted into corresponding chambers 54 of the micro-partition structure 50.

FIG. 4C shows the structure of still another electrophoresis display 100, the micro-partition structure 50 of the present invention is applicable to the shown electrophoresis display 100. The electrophoresis display 100 is an electrophoresis display 100 with double-sided control substrate. The double-sided control substrate 100 mainly includes, from top to bottom, a second control substrate 10U, a micro-partition structure 50, and a first control substrate 10D. Furthermore, the first control substrate 10D has a first face 10A and a second face 10B adjacent to the micro-partition structure 50. A first high-aperture drive circuit layer 30D (including a thin-film transistor circuit layer containing multiple thin-film transistor circuits) and a first pixel electrode layer PELD (including multiple first pixel electrodes PED) are arranged on the second face 10B of the first control substrate 10D. The second control substrate 10U has a fourth face 12B and a third face 12A adjacent to the micro-partition structure 50. A second high-aperture drive circuit layer 30U (including a thin-film transistor circuit layer containing multiple thin-film transistor circuits) and a second pixel electrode layer PELU (including multiple second pixel electrodes PEU) are arranged on the third face of the second control substrate 10U. According to one embodiment of the present invention, when fabricating the electrophoresis display 100 with double-sided control substrate, the micro-partition structure 50 having multiple cell walls 52 is fabricated on the first control substrate 10D. Furthermore, as shown in FIG. 4C, a first color filter layer CF-1 is formed on the first pixel electrode layer PELD, and a second color filter layer CF-2 is formed on the second pixel electrode layer PELU.

In above FIGS. 4A, 4B, and 4C, the pixel electrode layer (for example, the pixel electrode layer PEL in FIG. 4A) includes multiple pixel electrodes (PE, PEU, PED), with a pixel gap between two adjacent pixel electrodes PE. In the following description, the support structure 52 is, for example, arranged on the pixel gap. However, this example is not a limitation of the present invention. It should be noted that the support structure 52 may also be partially arranged atop the pixel due to design or process constraints. Furthermore, the control substrate 10 is a transparent substrate, such as a glass substrate or a polymer substrate; the opposite substrate 12 is also a transparent substrate, such as a glass substrate or a polymer substrate.

Furthermore, as shown in FIG. 4A, the average height H of the multiple support structures 52 protruding from the pixel electrode layers PEL, as viewed from the side, is no less than 5 micrometers. Although not explicitly shown in FIG. 4B and FIG. 4C, in FIG. 4B, the average height H of the multiple support structures 52 protruding from the pixel electrode layers PEL is no less than 5 micrometers; and in FIG. 4C, the average height H of the multiple support structures 52 protruding from the first pixel electrode layer PELD is also no less than 5 micrometers.

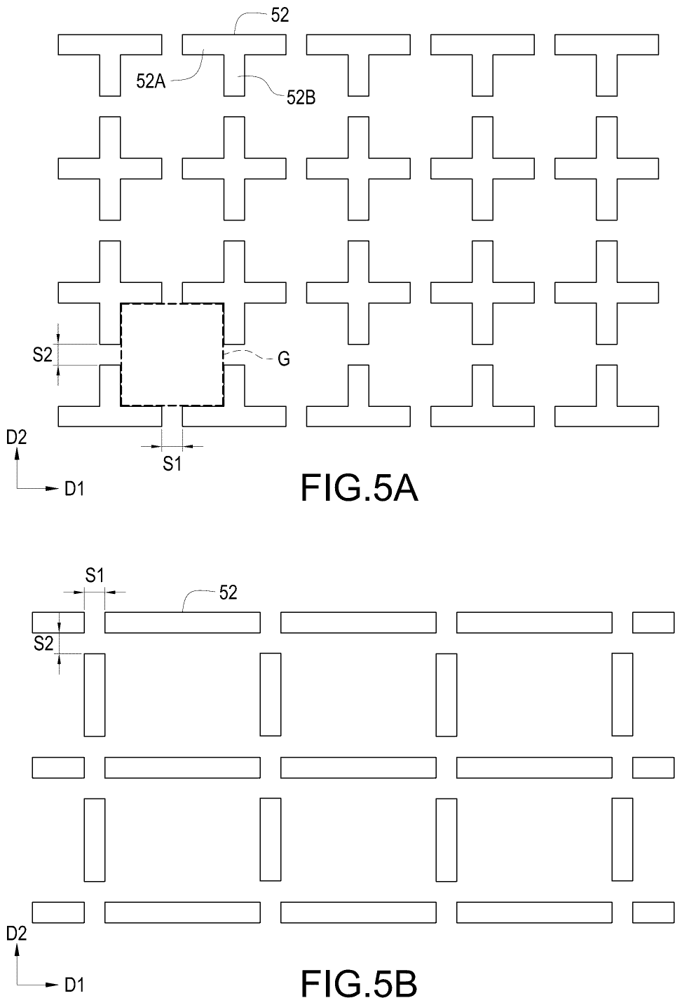

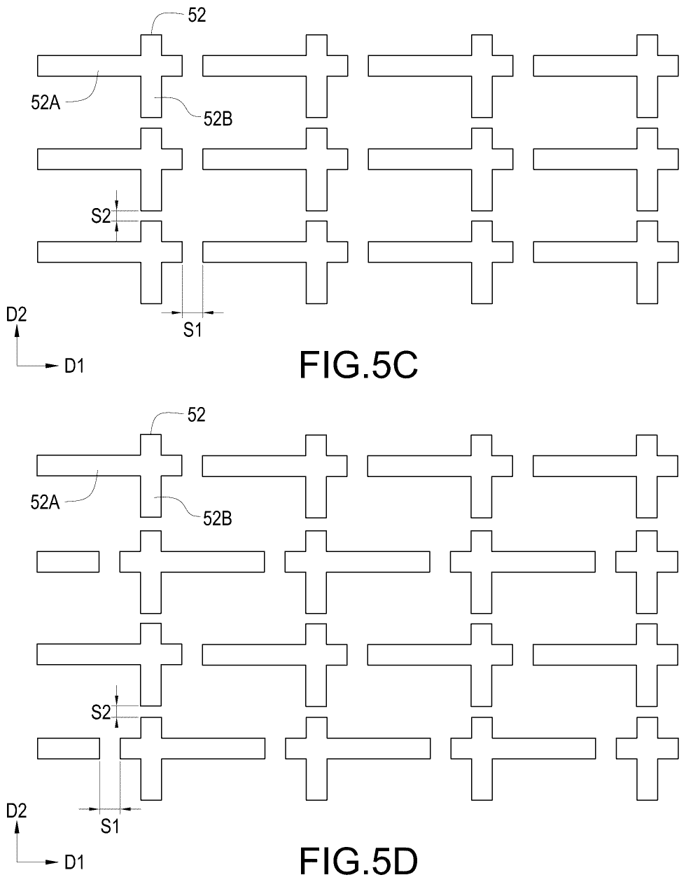

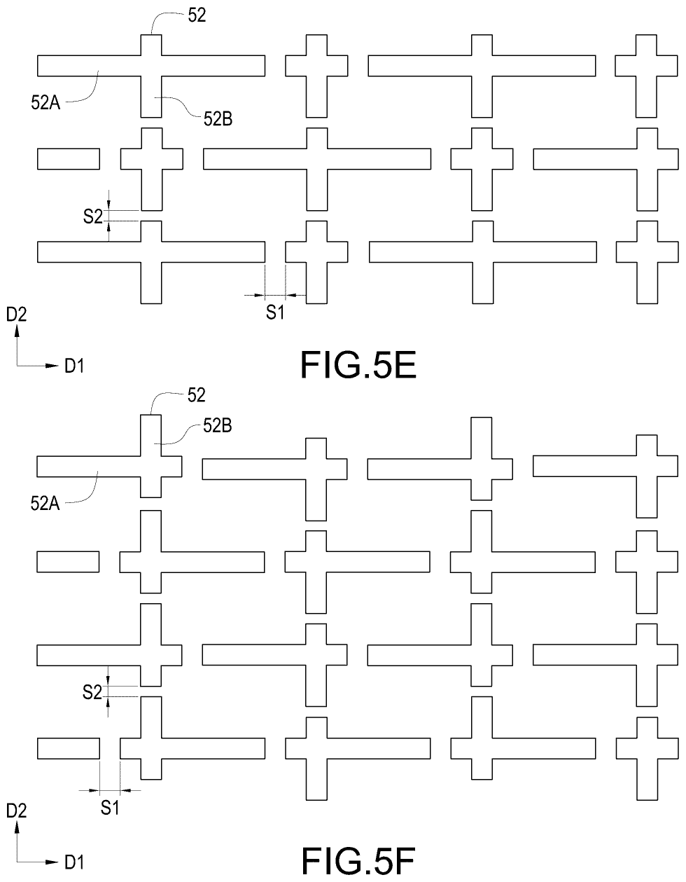

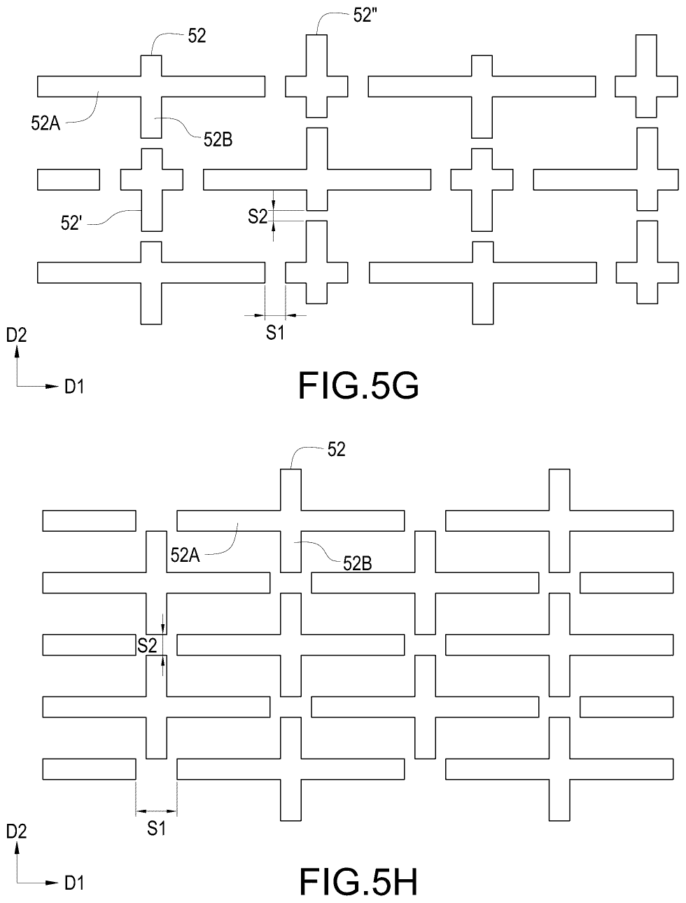

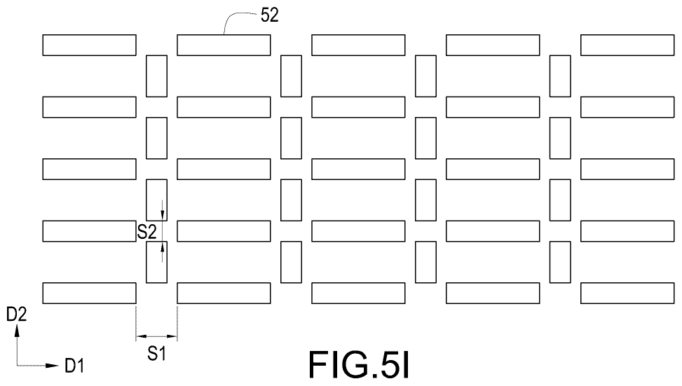

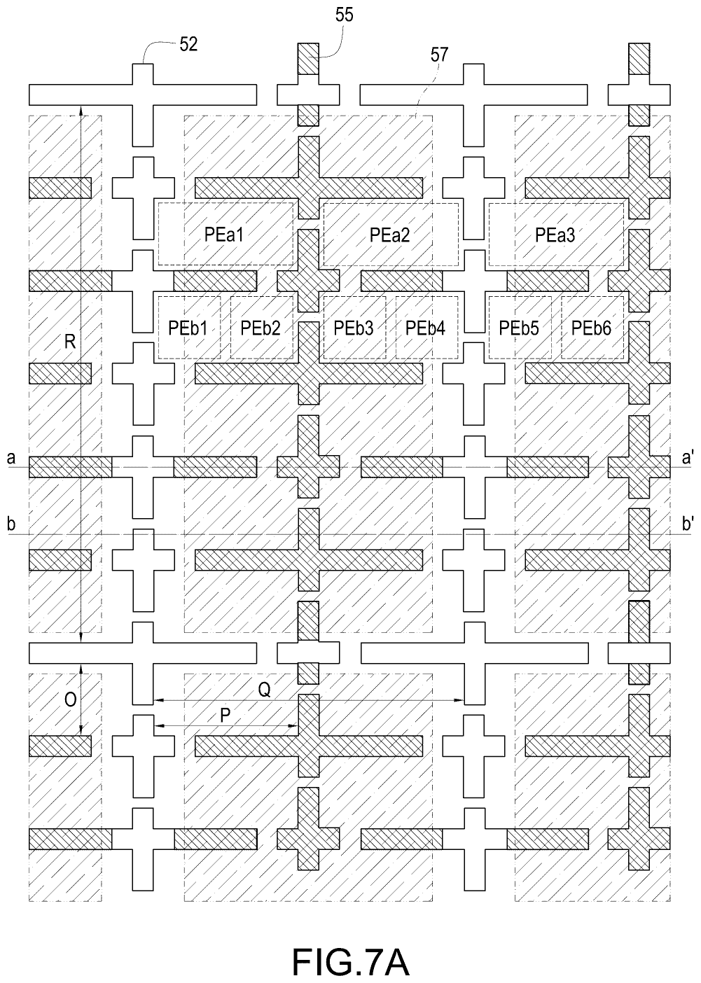

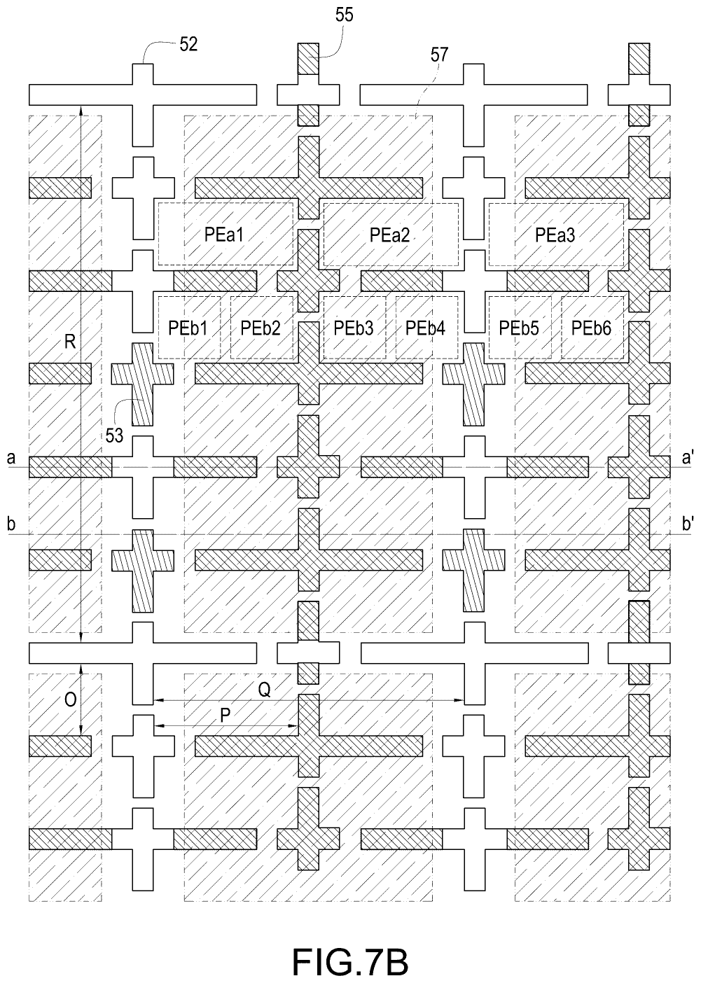

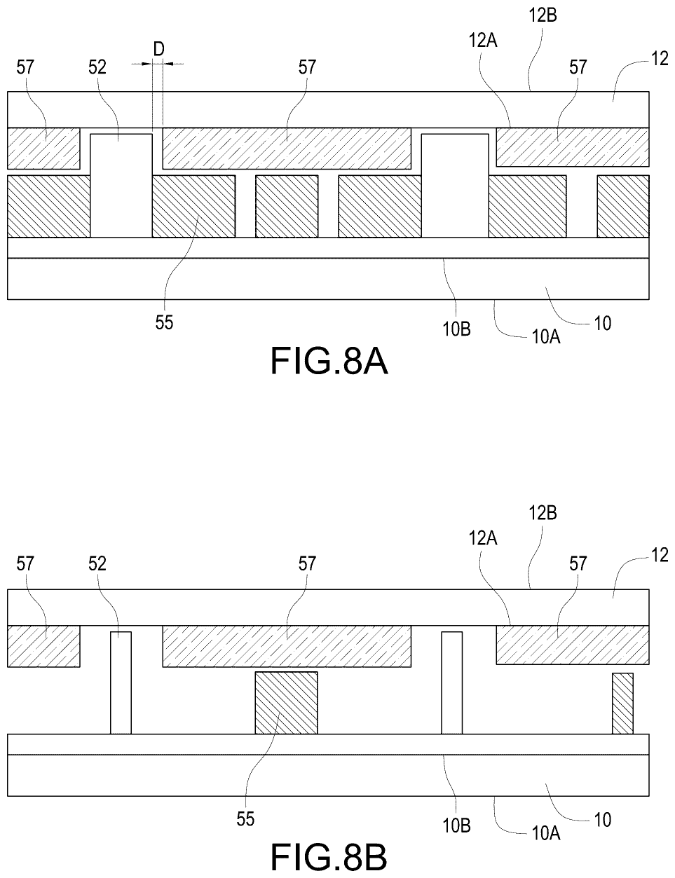

FIGS. 5A-5I are top views showing the support structures 52 according to different embodiments of the present invention, and with reference also to FIGS. 7A, 8A and 8B, wherein FIG. 7A shows the distribution of multiple support structures 52 on the surface of the electrophoresis display 100, and FIGS. 8A and 8B respectively show cross-sectional views along lines a-a′ and b-b′ in FIG. 7A.

As shown in FIG. 5A, the support structures 52 are generally of cross-shape and each includes a first structural part 52A extended along the transverse direction D1 and a second structural part 52B extended along the longitudinal direction D2. The first structural part 52A and the second structural part 52B intersect with each other at an intersection point. Although FIG. 5A shows that the first structural part 52A and the second structural part 52B intersects at an angle of nearly 90 degrees, the present invention is not limited to this specific embodiment. The first structural part 52A and the second structural part 52B may intersect at other angles, depending on the design of the chamber 54. Moreover, the adjacent support structures 52 have a first support structure gap S1 (along the transverse direction D1) therebetween. The adjacent support structures 52 have a second support structure gap S2 (along the longitudinal direction D2) therebetween. The first support structure gap S1 and the second support structure gap S2 may be of the same or different sizes. Besides, the first support structure gaps S1 along the transverse direction D1 are aligned in longitudinal direction, while the second support structure gaps S2 along the longitudinal direction D2 are aligned in transverse direction.

FIG. 5B shows a top view of the support structures 52 according to another embodiment of the present invention. The shown support structure 52 is generally of strip-shape. Moreover, the adjacent support structures 52 have a first support structure gap S1 (along the transverse direction D1) therebetween. The adjacent support structures 52 have a second support structure gap S2 (along the longitudinal direction D2) therebetween. The first support structure gap S1 and the second support structure gap S2 may be of the same or different sizes. In addition, the first support structure gaps S1 along the transverse direction D1 are aligned in longitudinal direction, while the second support structure gaps S2 along the longitudinal direction D2 are aligned in transverse direction.

FIG. 5C shows a top view of the support structures 52 according to another embodiment of the present invention. The support structures 52 in FIG. 5C are similar to the structure shown in FIG. 5A except that the first structural part 52A in FIG. 5C has longer extension on one side (such as leftward side in FIG. 5C) from the intersection point (along the transverse direction D1) than the extension on the other side (such as rightward side in FIG. 5C) from the intersection point. Similarly, the adjacent support structures 52 have a first support structure gap S1 (along the transverse direction D1) therebetween. The adjacent support structures 52 have a second support structure gap S2 (along the longitudinal direction D2) therebetween. The first support structure gap S1 and the second support structure gap S2 may be of the same or different sizes. Furthermore, the first support structure gaps S1 along the transverse direction D1 are aligned in longitudinal direction, while the second support structure gaps S2 along the longitudinal direction D2 are aligned in transverse direction.

FIG. 5D shows a top view of the support structures 52 according to another embodiment of the present invention. The support structures 52 in FIG. 5D are similar to the structure shown in FIG. 5C except than, at certain row of the support structures 52, the first structural part 52A in FIG. 5D has longer extension on one side (such as leftward side in FIG. 5D) from the intersection point (along the transverse direction D1) than the extension on the other side (such as rightward side in FIG. 5D) from the intersection point; and at next row, the first structural part 52A in FIG. 5D has shorter extension on one side (such as leftward side in FIG. 5D) from the intersection point (along the transverse direction D1) than the extension on the other side (such as rightward side in FIG. 5D) from the intersection point. In other words, the longer extensions of the first structural parts 52A in adjacent rows are staggered along the longitudinal direction D2. Similarly, the adjacent support structures 52 have a first support structure gap S1 (along the transverse direction D1) therebetween; the adjacent support structures 52 have a second support structure gap S2 (along the longitudinal direction D2) therebetween. The first support structure gap S1 and the second support structure gap S2 may be of the same or different sizes. In addition, the adjacent first support structure gaps S1 along the transverse direction D1 are not aligned in longitudinal direction (because the longer extension lengths of adjacent rows of first structural parts 52A are opposite to each other along the longitudinal direction D2), while the second support structure gaps S2 along the longitudinal direction D2 are aligned in transverse direction.

FIG. 5E is a top view of the support structures 52 according to another embodiment of the present invention. The support structures 52 shown in FIG. 5E are similar to the structures shown in FIG. 5A except that the first structural parts 52A shown in FIG. 5E have extensions with lengths extending along the transverse direction D1 from the intersection point, which are different from the lengths of the first structural parts 52A at the next row and the same column. In other words, the support structure 52 at a certain location has extensions with lengths extending along the transverse direction D1 from the intersection point, which are different from the extension lengths of the first structural parts 52A at four adjacent corners. Similarly, the adjacent support structures 52 have a first support structure gap S1 (along the transverse direction D1) therebetween; the adjacent support structures 52 have a second support structure gap S2 (along the longitudinal direction D2) therebetween. The first support structure gap S1 and the second support structure gap S2 may be of the same or different sizes. In addition, the adjacent first support structure gaps S1 along the transverse direction D1 are not aligned in longitudinal direction, while adjacent second support structure gaps S2 along the longitudinal direction D2 are aligned in transverse direction.

FIG. 5F shows a top view of the support structures 52 according to another embodiment of the present invention. The support structures 52 shown in FIG. 5F are generally similar to the structures shown in FIG. 5D except that the second structural parts 52B at certain column has longer extensions on one side (such as upper side) along the longitudinal direction D2 from the intersection point and shorter extensions on the other side (such as lower side) along the longitudinal direction D2 from the intersection point; while the second structural parts 52B at the next column has shorter extensions on one side (such as upper side) along the longitudinal direction D2 from the intersection point and longer extensions on the other side (such as lower side) along the longitudinal direction D2 from the intersection point. In other words, the longer extensions of the second structural parts 52A in adjacent columns extending along the longitudinal direction D2 are opposite from each other. Similarly, the adjacent support structures 52 have a first support structure gap S1 (along the transverse direction D1) therebetween; the adjacent support structures 52 have a second support structure gap S2 (along the longitudinal direction D2) therebetween. The first support structure gap S1 and the second support structure gap S2 may be of the same or different sizes. In addition, the adjacent first support structure gaps S1 along the transverse direction D1 are not aligned in longitudinal direction, while adjacent second support structure gaps S2 along the longitudinal direction D2 are not aligned in transverse direction.

FIG. 5G is a top view of the support structures 52 according to another embodiment of the present invention. The support structures 52 shown in FIG. 5G are similar to the structures shown in FIG. 5E except that in FIG. 5G, the support structure 52, in comparison with the support structure 52 at adjacent row and adjacent column, has different extending length along the longitudinal direction D2 from the intersection point. For example, the support structure 52′ shown in FIG. 5G has longer downward extension than upward extension along the longitudinal direction D2 from the intersection point, while the support structure 52″ shown in FIG. 5G, which is at adjacent row and adjacent column with the support structure 52', has shorter downward extension than upward extension along the longitudinal direction D2 from the intersection point. Similarly, the adjacent support structures 52 have a first support structure gap S1 (along the transverse direction D1) therebetween; the adjacent support structures 52 have a second support structure gap S2 (along the longitudinal direction D2) therebetween. The first support structure gap S1 and the second support structure gap S2 may be of the same or different sizes. In addition, the adjacent first support structure gaps S1 along the transverse direction D1 are not aligned with each other in the longitudinal direction, and the adjacent second support structure gaps S2 along the longitudinal direction D2 are not aligned with each other in the transverse direction.

FIG. 5H is a top view of the support structures 52 according to another embodiment of the present invention. The support structures 52 in FIG. 5H are substantially similar to the structures shown in FIG. 5A except that the first structural part 52A in FIG. 5H has longer extension along the transverse direction D1 from the intersection point than the extension along the longitudinal direction D2 from the intersection point. In addition, the second structural parts 52B extending in the longitudinal direction D2 of each row of support structures 52 are aligned with the first support structure gaps S1 of the first structural parts 52A arranged in the transverse direction D1. The first structural parts 52A extending in the transverse direction D1 of each column of support structures 52 are aligned with the second support structure gaps S2 of the second structural parts 52B arranged in the longitudinal direction D2. Similarly, the adjacent first support structure gaps S1 along the transverse direction D1 are not aligned with each other in the longitudinal direction, and the adjacent second support structure gaps S2 along the longitudinal direction D2 are not aligned with each other in the transverse direction.

FIG. 5I is a top view of the support structures 52 according to another embodiment of the present invention. The support structures 52 shown in FIG. 5I are similar to the structure shown in FIG. 5B. Nevertheless, the support structures 52 in FIG. 5B are more feasible in transverse flow, while the support structures 52 in FIG. 5I are more feasible to longitudinal flow.

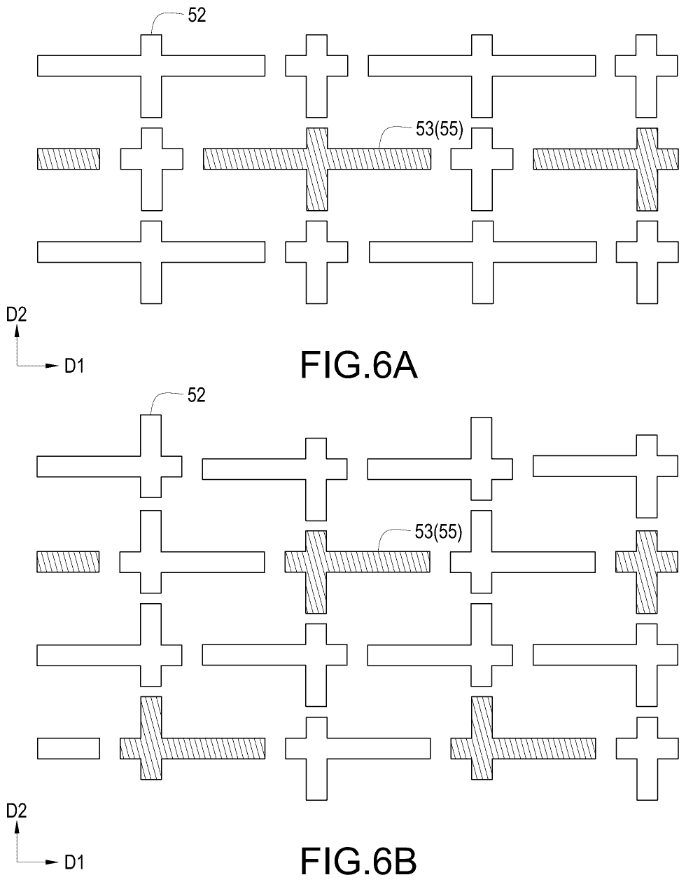

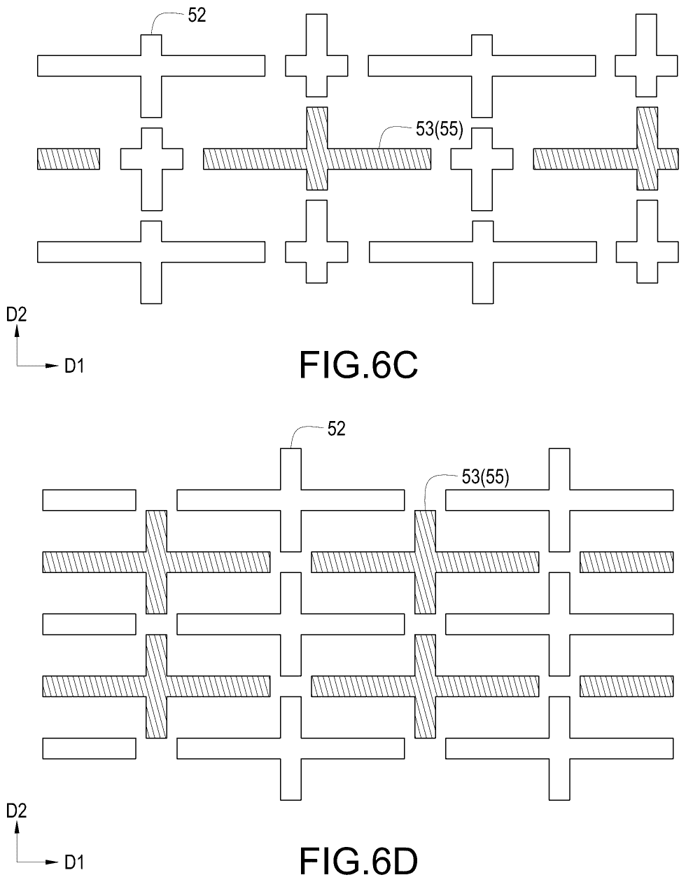

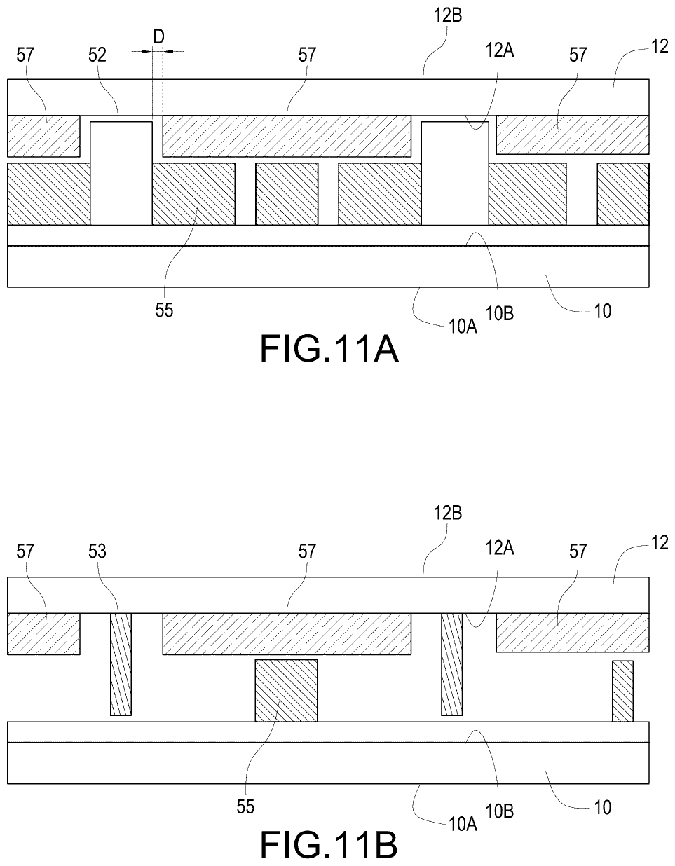

FIGS. 6A-6D are top views showing the support structures 52, 53 according to different embodiments of the present invention. Please refer also to FIGS. 7B, 11A and 11B, where FIG. 7B shows the distribution of multiple support structures 52, 53 on the surface of the electrophoresis display 100, and FIGS. 11A and 11B respectively shows cross-sectional views along lines a-a′ and b-b′ in FIG. 7B.

FIG. 6A shows a top view of the support structures 52 and 53 according to another embodiment of the present invention. The support structures 52 are generally similar to the structure shown in FIG. 5E. However, a portion of the support structures 52 in FIG. 5E (also referred to as the first support structure) are replaced by the support structure 53 (also referred to as the second support structure and shown as shaded). The support structures 52 are formed on the control substrate 10, while the support structures 53 are formed on the opposite substrate 12 (described in detail below).

FIG. 6B shows a top view of the support structures 52 and 53 according to another embodiment of the present invention. The support structures 52 (also referred to as the first support structure) are similar to the structure shown in FIG. 5F. However, a portion of the support structures 52 in FIG. 5F (also referred to as the first support structure) are replaced by the support structure 53 (also referred to as the second support structure and shown as shaded). The support structures 52 are formed on control substrate 10, while support structures 53 are formed on opposite substrate 12 (described in detail below).

FIG. 6C shows a top view of the support structures 52 and 53 according to another embodiment of the present invention. The support structures 52 (also referred to as the first support structure) are similar to the structure shown in FIG. 5G. However, a portion of the support structures 52 in FIG. 5G (also referred to as the first support structure) are replaced by the support structure 53 (also referred to as the second support structure and shown as shaded). The support structures 52 are formed on control substrate 10, while support structures 53 are formed on opposite substrate 12 (described in detail below).

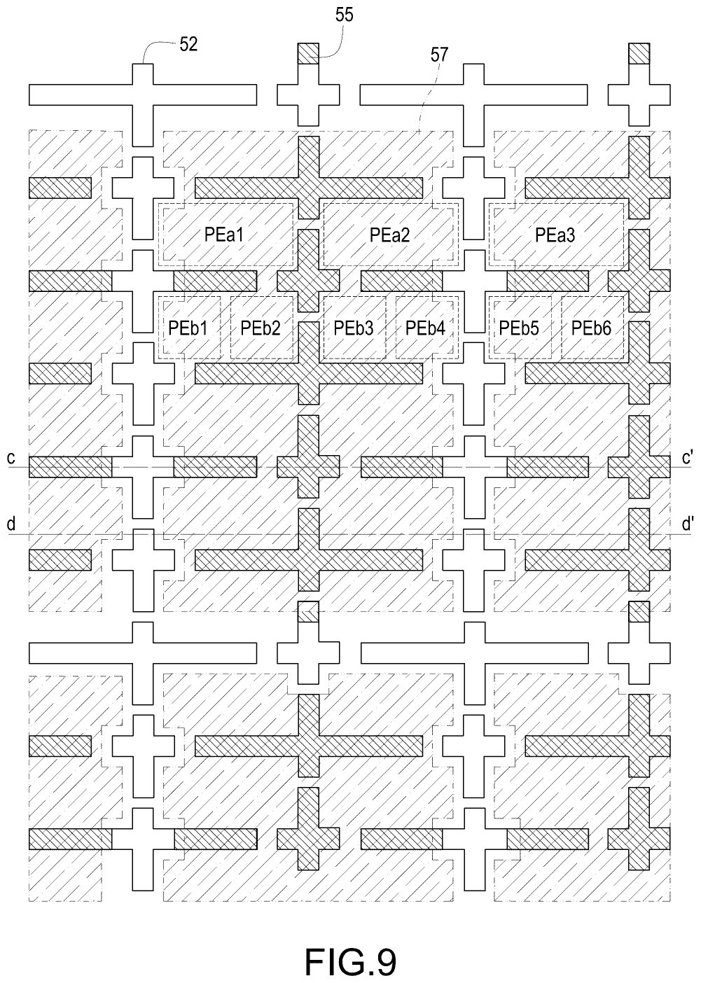

FIG. 6D shows a top view of the support structures 52 and 53 according to another embodiment of the present invention. The support structures 52 (also referred to as the first support structure) are similar to the structure shown in FIG. 5H. However, a portion of the support structures 52 in FIG. 5H (also referred to as the first support structure) are replaced by the support structure 53 (also referred to as the second support structure and shown as shaded). The support structures 52 are formed on control substrate 10, while support structures 53 are formed on opposite substrate 12 (described in detail below). In the embodiment of FIGS. 6A-6D described above, part or all of the support structure 53 may be replaced by the lower support structure 55 with lower height than the support structure 52. Referring also to FIGS. 7A, 7B, and 9, the support structure 52, the support structure 55, and/or the support structure 53 form a chamber 54. Referring also to FIGS. 8A, 8B, 10A, 10B, 11A, and 11B, the lower support structure 55 is formed on control substrate 10 and can be mated with protruding structures 57 formed on opposite substrate 12 to provide better support (details will be described later).

In the embodiments of FIGS. 5A-5I and 6A-6D, when a colloidal solution containing a plurality of suspended charged colored particles (electronic ink) is filled, the ink flows within the gaps in the support structure, facilitating uniform ink distribution. In addition, in the above embodiments, the gaps S1 and S2 in the support structure can have two different sizes and two different shapes to facilitate the control of the flowing manner and direction of the ink within the gaps in the support structure. Besides, in the embodiments of FIGS. 5A-5I and 6A-6D, at least one of the support structures encircles a chamber that can be filled with the colloidal solution containing the charged color particles. The ratio between the total width of the support structure gap corresponding to the chamber and the total perimeter of the chamber is greater than 5%. For example, with reference to FIG. 5A, the ratio between the total width of the support structure gap corresponding to the chamber (2 S1+2 S2) and the total perimeter G (highlighted by bold line) of the chamber is greater than 5%, thereby allowing a certain degree of ink flow within the support structure gap. Moreover, according to one embodiment of the present invention, the ratio between the total width of the support structure gap corresponding to the chamber and the total perimeter of the chamber is less than 30%, thus preventing excessive flow of ink between the gaps in the support structures and preventing excessive concentration of ink in certain chambers. Furthermore, according to one embodiment of the present invention, the ratio between the total width of the support structure gap corresponding to the chamber and the total perimeter of the chamber is between 10% and 15%. Furthermore, the average value of the maximum values of the support structure gaps is no greater than 1000 microns. Alternatively, the average value of the minimum values of the support structure gapes is no less than 1 micrometer (micron).

Refer to FIGS. 7A, 8A and 8B, where FIG. 7A shows the distribution of multiple support structures 52 on the surface of the electrophoresis display 100, FIGS. 8A and 8B respectively shows cross-sectional views along section line a-a′ and section line b-b′ in FIG. 7A. As shown in FIG. 7A, multiple adjacent support structures 52 and 55 can form a chamber 54. With reference to FIG. 8A, although a portion of the support structure 55 is covered by the protruding structure 57 when viewed from a projection direction, in order to more clearly show the formation of the chamber 54, the protruding structure 57 is depicted as a dotted line in FIG. 7A to more clearly illustrate the arrangement of the support structure 55. The chamber 54 can be filled with a colloidal solution containing a plurality of suspended charged color particles. In addition, the projection area of the chamber 54 can cover one pixel electrode (for example, pixel electrodes PEa1, PEa2, PEa3 shown in FIG. 7A) or multiple pixel electrodes (for example, pixel electrodes PEb1, PEb2, PEb3 . . . PEb6 shown in FIG. 7A).

As shown in FIG. 7A, the protruding structure 57 of the electrophoresis display 100 can be substantially rectangular when viewed from projection direction and cover at least one chamber 54, thereby providing a more stable mounting for the support structures 52 and 55. More specifically, the protruding structure 57 can be positioned at least on the lower support structure 55 to more effectively cover the chamber 54.

FIGS. 8A and 8B respectively shows cross-sectional views along section lines a-a′ and b-b′ of FIG. 7A. According to one embodiment of the present invention, the protruding structures 57 of the electrophoresis display 100 can be made of a polymer material. Moreover, a plurality of protruding structures 57 are disposed on the third face 12A of the opposite substrate 12 and can be embedded within the spaces between the support structures of the control substrate 10, such as the spaces O, P, Q, and R shown in FIG. 7A. As shown in FIG. 8A, the projection area of a protruding structure 57 on the opposite substrate covers multiple lower support structures 55, and the edge thereof is surrounded by multiple support structures 52 on the control substrate. A gap D is formed between the multiple support structures 52 surrounding a protruding structure 57 and the surrounded protruding structure 57, the width of the gap D is no less than 2 micrometers (microns).

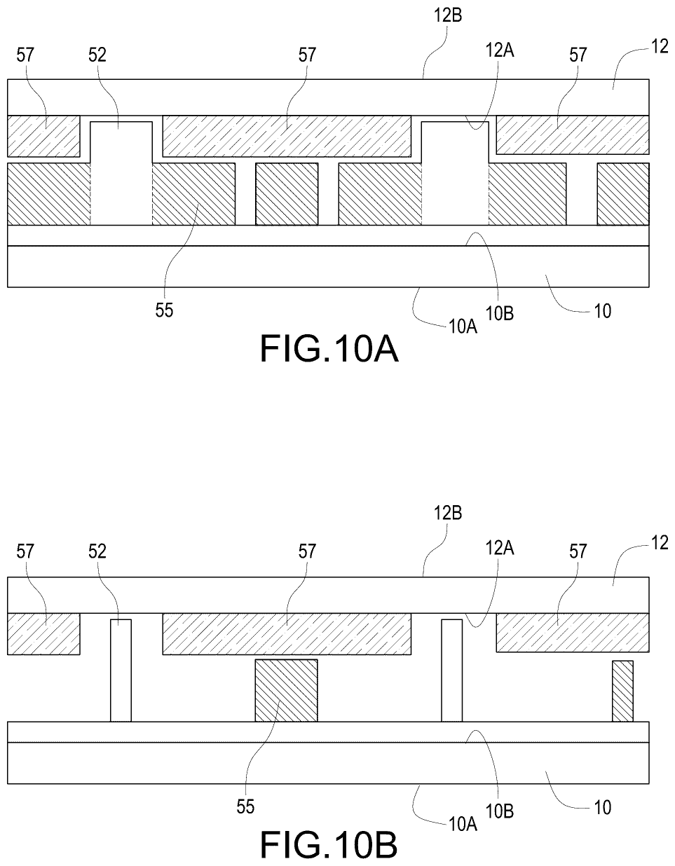

Refer to FIGS. 9, 10A and 10B, where FIG. 9 shows the distribution of the plurality of support structures 52 and 55 on the surface of the electrophoresis display 100, and FIGS. 10A and 10B respectively shows cross-sectional views along the section line c-c′ and the section line d-d′ of FIG. 9. As shown in FIG. 9, the plurality of support structures 52, 55 can form a chamber 54. The chamber 54 can be filled with a colloidal solution containing a plurality of suspended charged color particles. Moreover, the projection area of the chamber 54 can cover one or at least two pixel electrodes. Furthermore, in this embodiment, the protruding structure 57 of the electrophoresis display 100 has a serpentine shape around their periphery when viewed from a projection direction. The serpentine shape of the protruding structure 57 has better match with the support structures 52 and 55 having support structure gaps, thus allowing the protruding structure 57 to more effectively block a portion of the chamber 54.

As shown in FIGS. 10A and 10B, according to one embodiment of the present invention, the protruding structures 57 of the electrophoresis display 100 can be made of a polymer material. Moreover, multiple protruding structures 57 are disposed on the third face 12A of the opposite substrate 12 and can be embedded between the multiple support structures of the control substrate 10. As shown in FIG. 10A, the projection area of a protruding structure 57 on the opposite substrate 12 covers the multiple lower support structures 55, and the edges thereof are surrounded by the multiple support structures 52 of the control substrate. A gap D is formed between the multiple support structures 52 surrounding a protruding structure 57 and the surrounded protruding structure 57. The width of the gap is no less than 2 micrometers (microns).

Please refer to FIGS. 7B, 11A and 11B, where FIG. 7B shows the distribution of multiple support structures 52, 55, and 53 on the surface of the electrophoresis display 100, while FIGS. 11A and 11B respectively shows cross-sectional views along the section line a-a′ and the section line b-b′ of FIG. 7B. As shown in FIG. 7A, the support structures 52, 55, and the support structure 53 may form a chamber 54. In other words, the support structures 52 and 55 provided on the control substrate 10 and the support structure 53 provided on the opposite substrate 12 jointly enclose a plurality of chambers 54 filled with charged color particles. These chambers 54 can be filled with a colloidal solution containing a plurality of suspended charged color particles. In addition, the projection area of the chambers 54 can cover one pixel electrode (for example, pixel electrodes PEa1, PEa2, PEa3 shown in FIG. 7B) or at least two pixel electrodes (for example, pixel electrodes PEb1, PEb2, PEb3, . . . , PEb6 shown in FIG. 7B).

In addition, as shown in FIG. 11A and FIG. 11B, the support structures 52 and 53 may have different heights, wherein the height of the support structure 52 may be greater than the height of the support structure 53.

As shown in FIGS. 11A and 11B, the protruding structures 57 of the electrophoresis display 100 can be made of a polymer material. Furthermore, multiple protruding structures 57 are disposed on the third face 12A of the opposite substrate 12 and can be embedded in the spaces between the multiple support structures of the control substrate 10, such as the spaces O, P, Q, and R shown in FIG. 7B. As shown in FIG. 11A, the projection area of a protruding structure 57 on the opposite substrate covers the multiple lower support structures 55, and the edges thereof are surrounded by the multiple support structures 52 of the control substrate. A gap D is formed between the multiple support structures 52 surrounding a protruding structure 57 and the surrounded protruding structure 57. The width of the gap D is no less than 2 micrometers (microns).

While this invention has been described by means of specific embodiments, numerous modifications and variations may be made thereto by those skilled in the art without departing from the scope and spirit of this invention set forth in the claims.

What is claimed is:

1. An electrophoresis display having support structure, the electrophoresis display comprising:
a control substrate having a first face and a second face;
an opposite substrate having a third face and a fourth face;
an electrophoresis display material layer filled with a colloidal solution containing at least one type of charged color particles, the electrophoresis display material layer being arranged between the control substrate and the opposite substrate;
the electrophoresis display further comprising, on the second face of the control substrate;
a thin-film transistor circuit layer comprising a plurality of thin-film transistors, a plurality of gate lines, and a plurality of data lines, at least one of the gate lines being electrically connected to gates of the plurality of thin-film transistors, and at least one of the data lines being electrically connected to drains or sources of the plurality of thin-film transistors;
a pixel electrode layer comprising a plurality of pixel electrodes;
a plurality of support structures, the support structures having a support structure gap between two adjacent support structures;
wherein the support structure gaps have at least one size, and the colloidal solution is filled between the support structures; when the colloidal solution is filled, the colloidal solution flows within the support structure gaps;
wherein at least one of the support structures encloses a chamber capable of being filled with the colloidal solution containing the charged color particles, the ratio of a total width of the support structure gaps corresponding to the chamber to the total perimeter of the chamber is greater than 5%.

2. The electrophoresis display in claim 1, wherein one portion of the support structures are arranged on the control substrate and other portion of the support structures are arranged on the opposite substrate.

3. The electrophoresis display in claim 1, wherein the support structure gaps have at least two different sizes and/or at least two different shapes.

4. The electrophoresis display in claim 1, further comprising a common electrode layer arranged on the third face of the opposite substrate.

5. The electrophoresis display in claim 1, further comprising a color filter layer arranged on the third face of the opposite substrate.

6. The electrophoresis display in claim 1, wherein the control substrate is a transparent substrate.

7. The electrophoresis display in claim 1, further comprising a plurality of pixel electrodes arranged on the second face of the control substrate, wherein the plurality of pixel electrodes are transparent conductive electrodes.

8. The electrophoresis display in claim 7, further comprising a color filter layer arranged on the second face of the control substrate.

9. The electrophoresis display in claim 1, wherein an average height of the plurality of support structures protruding from the pixel electrodes, as viewed from lateral side, is not less than 5 micrometers.

10. The electrophoresis display in claim 1, wherein an average value of maximums of the support structure gaps is not greater than 1000 micrometers.

11. The electrophoresis display in claim 1, wherein an average value of minimum of the support structure gaps is not less than 1 micrometer.

12. The electrophoresis display d in claim 1, wherein the support structures have at least two different heights.

13. The electrophoresis display in claim 1, further comprising a plurality of protruding structures arranged on the third face of the opposite substrate, wherein the plurality of protruding structures are embedded between the plurality of support structures of the control substrate.

14. The electrophoresis display in claim 13, wherein a projected area of one of the protruding structures on the opposite substrate covers the plurality of support structures, and edges of one of the protruding structures are surrounded by the plurality of support structures of the control substrate.

15. The electrophoresis display in claim 14, wherein a gap is defined between the plurality of support structures surrounding one of the protruding structures and the surrounded protruding structure.

16. The electrophoresis display in claim 15, wherein an average size of the gaps is not less than 2 micrometers.

17. The electrophoresis display in claim 13, wherein the plurality of protruding structures are made of a polymer material.

18. The electrophoresis display in claim 1, wherein a projected area of one of the chambers covers at least one of the pixel electrodes.

19. The electrophoresis display in claim 1, wherein a projected area of one of the chambers covers at least two of the pixel electrodes.

20. The electrophoresis display in claim 1, further comprising another thin-film transistor circuit layer and another pixel electrode layer arranged on the third face of the opposite substrate.

21. The electrophoresis display in claim 1, wherein the opposite substrate is a transparent substrate.

22. The electrophoresis display in claim 2, wherein the support structure arranged on the control substrate and the support structure arranged on the opposite substrate jointly enclose a plurality of chambers filled with charged color particles.

23. The electrophoresis display in claim 1, wherein a pixel gap is defined between the two pixel electrodes, and the plurality of support structures are disposed in the pixel gaps.
